(19) United States
(12) Patent Application Publication
(10) Pub. No.: US 2003/0167943 A1
(43) Pub. Date: Sep. 11, 2003

(54) Printing machine

(76) Inventors: Hideo Izawa, Sakura-shi (JP); Yuichi Yamazaki, Higashi-Katsushika-gun (JP); Yasushi Katagiri, Kashiwa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/315,140

(22) Filed: Dec. 10, 2002

(30) Foreign Application Priority Data
Mar. 8, 2002 (JP) P2002-63744

(51) Int. Cl. B41F 5/04

(52) U.S. Cl. 101/223

(57) ABSTRACT

A printing machine includes two printing units, each comprising a web feed section, a web printing section connected to the web feed section and a web treating section connected to the web printing section, in which single-side surface of a continuous web is printed at each of the web printing sections, and an turn/transfer section at which two printing units are operatively connected and the continuous web printed by one of the two web printing sections is transferred to the other one thereof through turning and transferring treatment of the continuous web.

This printing machine is capable of carrying out double-side printing and single side printing and improving a printing efficiency with relatively small location space or site.

### BACKGROUND OF THE INVENTION

1. Field of the Invention

The present invention relates to a printing machine capable of selectively performing a double-side (perfect) printing and a single-side (simple) printing to a continuous web of paper (called “continuous web” or merely “web” hereinlater).

2. Related Art

A conventional printing machine of the kind mentioned above includes, for example, a double-side surface printing machine in which two printing units are disposed, via a turning device for changing a side of the web to be printed, on a traveling path for the continuous web, in which single-side surface of the web is printed by one of these two printing units, then the web is turned by a turning device, and the other single-side surface thereof is thereafter printed by the other one of the two printing units, thus performing double-side (perfect) printing.

Another conventional example of such printing machine is disclosed in Japanese Patent Laid-open (KOKAI) Publication No. 168035/2000 utilizing two printing units, in which web traveling paths in these two printing units are continuously connected so as to provide a hook shape or to be in parallel to each other in a manner such that a terminal end of a preceding one printing unit is arranged to be continuously connected to a starting end of a succeeding another one printing unit through a turn-bar mechanism. According to such printing machine, single-side surface of the continuous web is printed by one printing unit and, thereafter, the web is turned by the turn-bar mechanism, and the other single-side surface is then printed by the other printing unit.

However, in the conventional printing machine of the structure mentioned above as former example, in a case where only single-side surface printing is required to one continuous web, one of two printing units is not used, and hence, in such case, the printing rate is made worse and deteriorated, thus being inconvenient.

On the other hand, in the later mentioned conventional example, single-side surface printing can be performed by each of these two printing units, so that the printing machine is suitably applicable as single-side printing unit. However, the two printing units in this example are arranged to be in hook-shape or in parallel to each other, so that much location space is to be needed, thus being defective.

### SUMMARY OF THE INVENTION

The present invention was conceived to substantially eliminate defects or inconveniences encountered in the prior art mentioned above and provides a printing machine including two printing units capable of carrying out double-side surface printing, and in the case of single-side surface printing, both printing units can be utilized as single-side surface printing unit, to thereby improve a printing efficiency with relatively small location space or site.

This and other objects can be achieved according to the present invention by providing, in a main aspect, a printing machine comprising:

two printing units, each comprising a web feed section, a web printing section connected to the web feed section and a web treating section as like as a web wind-up section connected to the web printing section, in which single-side surface of a continuous web is printed at each of the web printing sections; and

a turn/transfer section formed between the web printing section and the web treating section of one of the printing units, for turning and transferring the continuous web, which is printed by one of two web printing sections, to the other one thereof through turning and transferring operation of the continuous web.

In another aspect of the present invention, there is also provided a printing machine comprising:

first and second printing units, the first and second printing units comprising first and second web feed sections, first and second web printing sections connected to the first and second web feed sections, respectively, and first and second web treating sections connected to the first and second web printing sections, respectively, in which single-side surface of a continuous web is printed at each of the first and second web printing sections; and

a turn/transfer section formed at an intersecting portion between a first portion between the first web printing section and the first web treating section and a second portion between the second web feed section and the second web printing section, in which the continuous web printed at the first web printing section of the first printing unit is turned and transferred in a cross-over manner to the web second printing section of the second printing unit.

In a further aspect of the present invention, there is also provided a printing machine comprising:

first and second printing units, the first and second printing units comprising first and second web feed sections, first and second web printing sections connected to the first and second web feed sections, respectively, and first and second web treating sections connected to the first and second web printing sections, respectively, in which single-side surface of a continuous web is printed at each of the first and second web printing sections, wherein each of the first and second web feed sections of the first and second printing units is arranged at a portion on single-side in a direction perpendicular to a printing direction in the web printing section through one turning bar and each of the first and second web treating sections of the first and second web printing units is arranged at a portion on another single-side in the direction perpendicular to the printing direction in the printing section through another turning bar; and

a turn/transfer section formed at a connecting portion between the first and second web printing sections which are arranged on a same linear line, so as to transfer the continuous web printed at the first web printing section of the first printing unit to the second web printing section of the second printing unit as it is or in a turned state.

In the printing machines mentioned above, each of the first and second web printing sections includes a printing device and a drier disposed downstream side of the printing device.

The first and second printing units maybe driven sectionally synchronously or independently.

According to the printing machine of the characters mentioned above, two, i.e. first and second, printing units perform the single-side printing operations respectively independently. By utilizing the turn/transfer section, the continuous web which has been printed on single-side surface at the one (first) printing section of one (first) printing unit is turned and transferred, in the cross-over manner, by the turn/transfer section, to the other (second) printing section of the other (second) printing unit, at which the other single-side surface is printed, thus double-side surfaces being printed.

Therefore, according to the printing machine of the present invention, in which single- or double-side printing operation can be selectively performed, two printing units can be independently utilized to thereby improve the driving (working) performance of the printing machine.

Furthermore, according to the arrangement in which there is disposed the turn/transfer section between the printing section and the continuous web feed section of one of the printing units so as to turn and transfer the continuous web, printed by the printing section, to the printing section of the other of the printing units, both the printing units intersect at their intermediate portions, thus making compact the printing machine itself and hence reducing an installation space thereof.

Particularly, in the arrangement in which the web feed section is disposed on single-side in the perpendicular direction to the printing section and the continuous web treating section is disposed on the other side in the perpendicular direction of the printing unit, the installation space can be further minimized.

The above and other objects, and nature and further characteristic features of the present invention will be made more clear from the following descriptions made with reference to the accompanying drawings.

### BRIEF DESCRIPTION OF THE DRAWINGS

In the accompanying drawings:

FIG. 1 is a plan view schematically showing a printing machine according to a first embodiment of the present invention;

FIG. 2 is a plan view schematically showing a printing machine according to a second embodiment of the present invention; and

FIG. 3 is an illustration for explaining construction and function of an turn/transfer mechanism of the second embodiment of FIG. 2.

### DESCRIPTION OF THE PREFERRED EMBODIMENTS

Preferred embodiments of the present invention will be described hereunder with reference to the accompanying drawings.

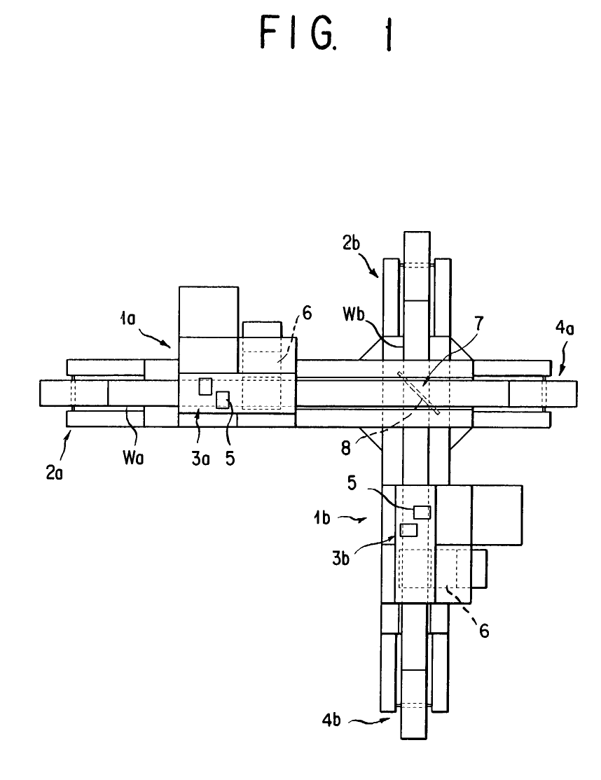

With reference to FIG. 1, showing the first embodiment of the present invention, a printing machine of this embodiment includes a first printing unit la and a second printing unit 1b, which are provided with web feed sections 2a, 2b, web printing sections 3a, 3b and web wind-up (roll-up) sections 4a, 4b, respectively.

Continuous webs of paper (hereinlater called “continuous web” or merely “web”) fed from the web feed sections 2a and 2b are printed respectively at the web printing sections 3a and 3b and then wound up at the web wind-up sections 4a and 4b. The printing sections 3a and 3b includes printing devices 5 and dryers 6 are disposed downstream side of the printing devices 5 in the web feed direction.

The first printing unit la includes a traveling path having a predetermined length between the printing section 3a and the wind-up section 4a, and on the other hand, the second printing unit 1b includes a traveling path having a predetermined length between the web feed section 2b and the printing section 3b. Both these traveling paths are arranged to intersect at a right angle with each other, and the intersecting portion is formed as turn/transfer section 7.

This turn/transfer section 7 is provided with a turning bar 8 for turning a continuous web Wa traveling on the traveling path of the first printing unit la and the turned continuous web Wa is then transferred to the traveling path of the second printing unit 1b to thereby guide the web Wa to the printing section 3b.

Each of these printing units 1a and 1b is equipped with a driving servo-motor, for sectional driving, to be controlled by a drive-control device, not shown, to allow the printing units 1a and 2b to be driven so as to carry out the printing operations independently or synchronously with each other in an interlocking manner.

In the first embodiment of the arrangement described above, the continuous web Wa fed from the web feed section 2a of the first printing unit 1a passes through the printing section 3a of this first printing unit 1a, is then turned and bent by the turning bar provided for the turn/transfer section 7 and transferred to the traveling path of the second printing unit 1b. The continuous web Wa is thereafter passes through the printing section 3b and the wind-up section 4b, and under this condition, both the printing units 1a and 1b are driven and controlled so as to carry out the synchronous operation, whereby both the sides of the continuous web Wa can be printed.

On the other hand, in the first printing unit 1a, the continuous web Wa is fed from the web feed section 2a to the web wind-up section 4a through the web printing section 3a the without being subjected to any operation at turn/transfer section 7.

Further, in the second printing unit 1b, the continuous web Wb is fed from the web feed section 2b to the web wind-up section 4b through the web printing section 3b without being subjected to any operation at the turn/transfer section 7. Under such condition, by individually driving both the printing units 1a and 1b, the continuous webs Wa and Wb are subjected to single-side surface printing, respectively.

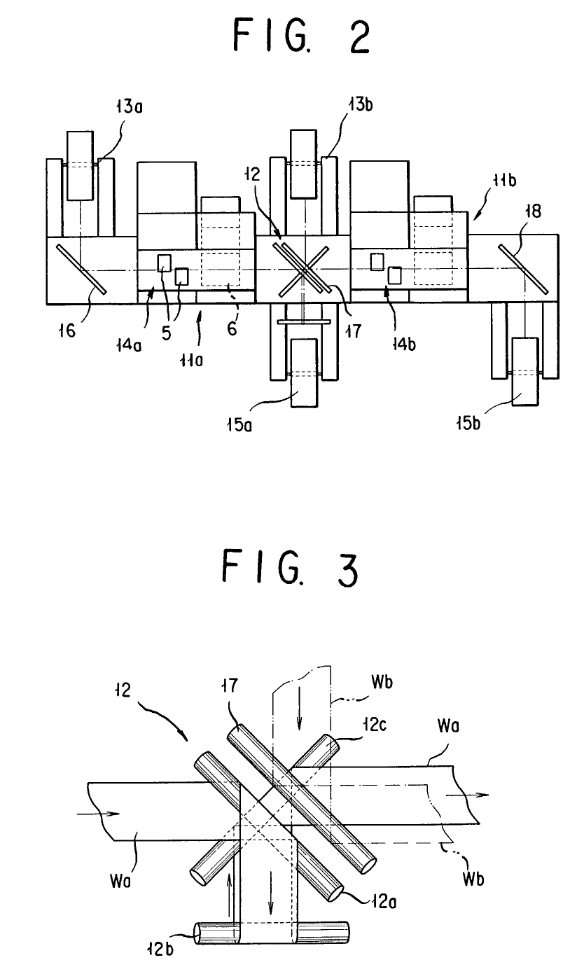

Next, the second embodiment of the present invention will be described with reference to FIGS. 2 and 3.

Referring to FIG. 2, the printing machine of this second embodiment includes first and second printing units 11a and 11b, which are interlocked with each other by means of turn/transfer section 12 at an intermediate step of the printing process of the printing units 11a and 11b.

The first printing unit 11a is provided with a first web feed section 13a, a first web printing section 14a and a first web wind-up section 15a, and on the other hand, the second printing section 11b is also provided with a second web feed section 13b, a second web printing section 14b and a second web wind-up section 15b.

The first and second printing sections 14a and 14b are arranged on the same line in series, and the turn/transfer section 12 is disposed between these first and second printing sections 14a and 14b.

The first web feed section 13a is disposed to single-side position approximately perpendicular to the web printing direction (i.e. web feed direction) on the upstream side of the first printing section 14a via a first web feed side turning bar 16. On the other hand, the second web feed section 13b is also disposed to that single-side position approximately perpendicular to the web printing direction (i.e. web feed direction) on the upstream side of the second printing section 14b via a second web feed side turning bar 17.

Furthermore, the first wind-up section 15a is disposed to the other single-side position approximately perpendicular to the web printing direction on the downstream side of the first printing section 14a via the turn/transfer section 12. On the other hand, the second wind-up section 15b is disposed to the other single-side position approximately perpendicular to the web printing direction on the downstream side of the second printing section 14b via the second turning bar 18.

With reference to FIG. 3, the turn/transfer section 12 is provided with a first turning bar 12a for turning, by 90 degrees, and then guiding the continuous web Wa from the first printing section 14a to the first wind-up section 15a, a second turning bar 12b for turning, by 180 degrees, the continuous web Wa guided by the first turning bar 12a and a third turning bar 12c for turning, by 90 degrees, and then guiding the continuous web Wb guided by the second turning bar 12b to the second printing section 14b.

In this second embodiment, it is possible to carry out (1) double-side (perfect) printing, (2) single-side (simple) printing and (3) single-side multi-color printing in the following manner.

(1) In the double-side printing, the continuous web Wa from the first web feed section 13a is turned by 90 degrees by the web feed side turning bar 16 to thereby pass the first printing section 14a. The continuous web Wa is then turned by 90 degrees by the first turning bar 12a of the turn/transfer section 12, again turned by 180 degrees by the second turning bar 12b and further turned by 90 degrees by the third turning bar 12c to thereby transfer the web Wa to the second printing unit 11b. Under this condition, the continuous web Wa is turned so that the back surface thereof is exposed upper side and is positioned on the printing line passing the first and second printing sections 14a and 14b with the back surface thereof being exposed upper side, and the continuous web Wa in this state passes through the second printing section 14b and then through the second wind-up section 15b by way of the wind-up side turning bar 18.

Under the state mentioned above, when both the printing units 11a and 11b are driven, one surface (front surface) of the continuous web Wa, which is fed from the web feed section 13a, is printed by the first printing section 14a and the other one surface (back surface) thereof is then printed by the second printing section 14b, thus both surfaces of the continues web Wa being printed.

(2) In the single-side printing, the continuous web Wa is fed from the first web feed section 13a of the first printing unit 11a and then turned by 90 degrees by the first web feed side turning bar 16 to thereby pass through the first printing section 14a. Thereafter, the continuous web Wa is turned by 90 degrees by the first turning bar 12a of the turn/transfer section 12 to pass through the first wind-up section 15a. Under the state, when the first printing unit 11a is driven, only the single-side surface of the continuous web Wa is printed.

On the other hand, in substantially the same manner, the continuous web Wb is fed from the second web feed section 13b of the second printing unit 11b and then turned by 90 degrees by the second web feed side turning bar 17 to thereby pass through the second printing section 14b and then through the second wind-up section 15a. There after, under this condition, when the second printing unit 11b is driven, the single-side surface of the continuous web Wb is printed.

(3) In the single-side surface multi-color printing, the continuous web Wa fed from the first web feed section 13a and passing through the first printing section 14a passes, as it is, the turn/transfer section 12 and the second web feed side turning bar 17, and passes through the second printing section 14b and the second wind-up section 15b. Under this state, when both the printing units 11a, 11b are driven, the multi-color printing is effected to the single-side surface of the continuous web Wa at both the printing sections 14a, 14b.

In this second embodiment, as like as in the first embodiment, the printing sections 14a, 14b of the first and second printing units 11a, 11b are equipped with printing devices 5 and the dryers 6, respectively. Further, the respective printing units 11a, 11b are equipped with servo-motors for driving, which are controlled by drive-control devices, not shown, so as to perform sectional driving operations, respectively.

Further, the wind-up sections 4a, 4b and 15a, 15b in both the first and second embodiments may be substituted with folding devices or sections so as to carry out folding treatment of the continuous webs Wa and Wb from the printing sections 3a, 3b and 14a, 14b, respectively.

It is further noted that, although the present invention is disclosed with reference to the preferred embodiments of the printing machine, the present invention is not limited to such specific embodiments, and many other applications will be suggested for those skilled in the art. Furthermore, it will be caused for experts in this art field to make various amendments, modifications and changes in the details of the illustrated and described embodiments so as to be conformed with design or the like or with the necessity of the applications.

What is claimed is:

1. A printing machine comprising:
two printing units, each comprising a web feed section, a web printing section connected to the web feed section and a web treating section connected to the web printing section, in which single-side surface of a continuous web is printed at each of the web printing sections; and
a turn/transfer section formed between the web printing section and the treating section of one of the printing unit, for turning and transferring the continuous web, which is printed by one of said two web printing sections, to the other one thereof through turning and transferring treatment of the continuous web at the turn/transfer section.

2. A printing machine comprising:
first and second printing units, said first and second printing units comprising first and second web feed sections, first and second web printing sections connected to the first and second web feed sections, respectively, and first and second web treating sections connected to the first and second web printing sections, respectively, in which single-side surface of a continuous web is printed at each of the first and second web printing sections; and
a turn/transfer section formed at an intersecting portion between a first portion between the first web printing section and the first web treating section and a second portion between the second web feed section and the second web printing section, in which the continuous web printed at the first printing section of the first printing unit is turned and transferred in a cross-over manner to the second web printing section of the second printing unit.

3. A printing machine according to claim 2, wherein each of said first and second web printing sections includes a printing device and a drier disposed downstream side of the printing device.

4. A printing machine according to claim 2, wherein said first and second printing units are driven sectionally and synchronously with each other at both-side printing operation or driven independently at single-side printing operation.

5. A printing machine comprising:
first and second printing units, said first and second printing units comprising first and second web feed sections, first and second web printing sections connected to the first and second web feed sections, respectively, and first and second web treating sections connected to the first and second web printing sections, respectively, in which single-side surface of a continuous web is printed at each of the first and second web printing sections, wherein each of said first and second web feed sections of the first and second printing units is arranged at a portion on single-side in a direction perpendicular to a printing direction in the web printing section through one turning bar and each of said first and second web treating sections of the first and second printing units is arranged at a portion on another single-side in the direction perpendicular to the printing direction in the printing section through another turning bar; and
a turn/transfer section formed at a connecting portion between said first and second web printing sections which are arranged in a same linear line, so as to transfer the continuous web, printed at the first web printing section of the first printing unit, to the second web printing section of the second printing unit as it is or in a turned manner.

6. A printing machine according to claim 5, wherein each of said first and second web printing sections includes a printing device and a drier disposed downstream side of the printing device.

7. A printing machine according to claim 5, wherein said first and second printing units are driven sectionally.
